(19) United States
(12) Patent Application Publication
(10) Pub. No.: US 2010/0284733 A1
(43) Pub. Date: Nov. 11, 2010

(54) Axial Ball Joint with Impact Damping Mechanism

(75) Inventors: Rainer Ungruh, Horstel (DE); Volker Grube, Diepholz (DE); Jens Diekhoff, Lemforde (DE); Markus Mollmann, Neuenkirchen (DE); Benjamin Ziebart, Wallenhorst (DE); Dirk Mahlmann, Vechta (DE)

Correspondence Address: Hildebrand, Christa;Norris McLaughlin & Marcus PA, 875 Third Avenue, 8th Floor, New York, NY, 10022, US

(73) Assignee: ZF FRIEDRICHSHAFEN AG, Friedrichshafen (DE)

(21) Appl. No.: 12/811,106

(22) PCT Filed: Dec. 10, 2008
(86) PCT No.: PCT/DE08/50042

§ 371 Date: Jun. 29, 2010

(30) Foreign Application Priority Data
Jan. 31, 2008 (DE) 10 2008 007 107.2

(51) Int. Cl. F16C 11/08

(52) U.S. Cl. 403/133

(57) ABSTRACT

The invention relates to an axial ball joint (1) in particular for use in a steering gear including a housing (2), open on one side, with a housing pin (3) arranged up front, a ball joint (4) with a pivot pin (5) and a bearing (6) which is arranged between housing (2) and ball joint (4), wherein the housing (2) has at least one elastic damping element (7) for impact damping on the side of the housing equipped with the housing pin (3).

The invention relates to an axial ball joint, in particular for use with a steering gear, with a housing that is open to one side and has a housing pin arranged at the front, a ball with a pivot pin and a bearing shell arranged between housing and ball.

Similar axial ball joints are generally known and are used particularly in the field of automobile steering gears, wherein the steering gears include a corresponding limit stop in the region of maximum displacements. If the steering gear is moved to the corresponding region of the limit stop, then the mechanical limit stop of the steering displacement causes a hard stop of the steering gear in the end region. This problem is known since some time, and attempts have therefore been made to develop an impact damping mechanism for such steering gears. For example, reference is made here to the documents EP 1 122 149 A1, U.S. Pat. No. 5,788,009, DE 600 01 626 T2, DE 697 25 931 T2, EP 1 429 951 B1 and JP 08-133 102 A. These documents describe steering gears which include damping systems for impact damping of the steering gear. However, the damping systems described therein have a relatively complex design and are arranged on the universal shaft and/or on the housing of the steering gear.

It is therefore an object of the invention to provide a damping mechanism for an axial ball joint which can be easily integrated in the vehicle steering mechanism.

This object is attained with the features of the independent claim. Advantageous embodiments are recited in the dependent claims and in the specification.

The inventors have become aware of that the design of a vehicle steering gear with impact damping can be significantly simplified by arranging the required damping element in the axial ball joint itself, in particular when an elastic damping element for impact damping is integrated on the housing side of the housing of the axial ball joint, which is provided with a pivot pin.

According to this fundamental concept, the inventors propose an axial ball joint, in particular for use in a steering gear, which includes a housing which is open on one side and has a housing pin arranged at the front, a ball with a pivot pin and a bearing shell arranged between the housing and the ball, wherein with the improvement according to the invention, the housing has on the housing side, which is provided with the pivot pin, at least one elastic damping element for impact damping.

This embodiment of the axial ball joint obviates the need for a complex structure of a steering gear and/or a relatively complex installation of a steering mechanism, because damping of the vehicle steering mechanism or the steering gear, respectively, is produced only by a suitably configured axial ball joint.

In an advantageous embodiment of the invention, the inventors propose that the damping element has an annular shape, whereby an unprotected housing surface, which is set back with respect to the at least one annular damping element, is preferably formed between the annular damping element and the housing pin. This has the effect that when the steering mechanism strikes the maximum deflection or the steering gear is otherwise sudden strongly loaded, the damping element responds first, whereas for an overly large load, a metal impact surface, namely the unprotected housing surface, is again available.

In this way, the elastic damping element cannot be destroyed by excessive compression.

Advantageously, the annular damping element may be inserted in a shoulder on the housing side of the housing that has the pivot pin; alternatively, a groove can be provided on the housing side of the housing that has the housing pin, wherein the annular damping element can be inserted in the groove.

The damping element may at least be partially made of an elastomer. For example, the annular damping element may be produced from a plastic ring and an elastomer overmolded over the ring. Advantageously, the plastic ring adds to the dimensional stability of the damping element and the plastic ring may be easily clamped onto the housing, whereas the overmolded elastic elastomer takes over the axial damping work.

The annular damping element may be, for example, vulcanized directly onto the housing. Alternatively, however, this annular damping element may be directly adhesively bonded on the housing or pressed onto the housing.

Sufficient elasticity of the damping element can also be achieved by constructing the plastic ring with an elastic response, i.e., the plastic ring may have a V-shaped configuration or a W-shaped configuration, as viewed in cross-section of the plastic ring, so that the plastic ring can be compressed with elastic deformation. The plastic ring then operates like a spring.

Additionally, the annular damping element may also be provided with a metal insert which, on one hand, provides a secure seat for the annular damping element in a groove or on a shoulder on the housing. On the other hand, this metal insert may also operate as an additional elastic component, thereby optionally providing the damping element with two-step elasticity.

To improve the seat of the annular elastic damping element and add firmness, the shoulder or the groove may additionally have an undercut, for example in form of an additional groove or in form of a conical shape of the shoulder, so that the elastic damping element may be clipped in this groove; alternatively, a positive lock may be produced with suitable vulcanization, which prevents the damping element from becoming easily detached.

It should be noted that the aforedescribed rotationally-symmetric damping element can not only be used as a single damping element in the region of the housing side of the housing that ahs the pivot pin, but several concentrically arranged annular damping elements with the aforedescribed properties may be installed, if enough installation space is available, commensurate with the size of the axial ball joint.

According to another embodiment of the axial ball joint of the invention, a plurality of damping elements are placed on the housing side of the housing of the axial ball joint that has the pivot pin, wherein the damping elements are no longer rotationally symmetric with respect to the rotation axis of the housing, but several elements are arranged about the rotation axis.

The damping elements may have different shapes, wherein damping elements in the shape of a segment of a circle or a circle, optionally also elliptical damping elements, should be mentioned as preferred embodiments.

It is proposed to install these damping elements on the housing side of the housing provided that has the pivot pin, by inserting the damping elements in recesses disposed in the housing. These damping elements may at least be partially made of an elastomer or of a combination of plastic and an elastomer overmolded over the plastic.

The damping elements may also be directly vulcanized on the housing or adhesively bonded to the housing.

The damping elements may also be pressed into respective recesses disposed on the housing side of the housing that has the pivot pin, wherein a metal insert may advantageously be employed which adds dimensional stability to the damping elements. Moreover, the recesses may also include undercuts for improved seating of the employed damping elements.

The invention will now be described with reference to the Figures, where only the features necessary for an understanding of the invention are illustrated.

It is shown in:

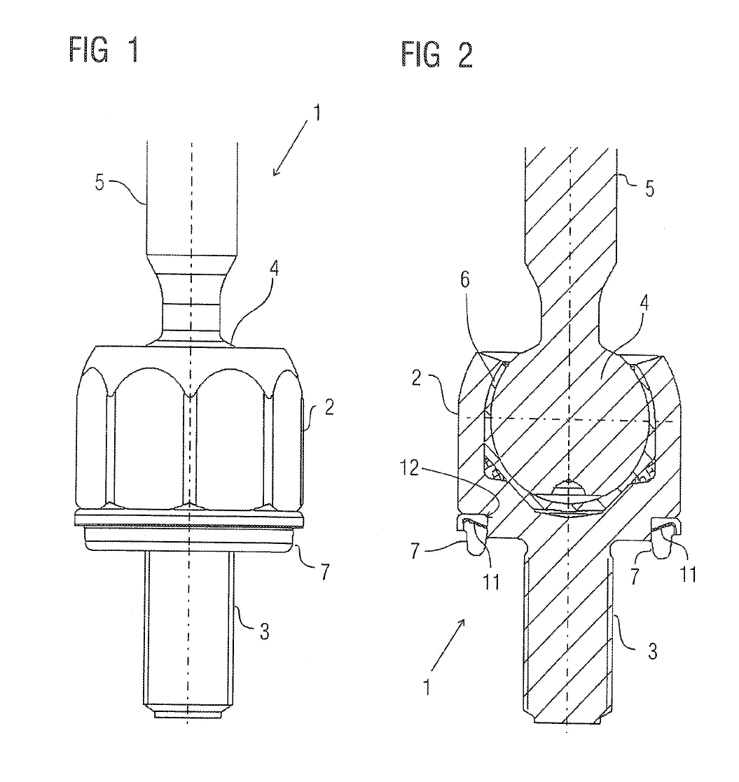

FIG. 1 a side view of an axial ball joint with impact damping mechanism;

FIG. 2 a longitudinal section through the axial ball joint of FIG. 1;

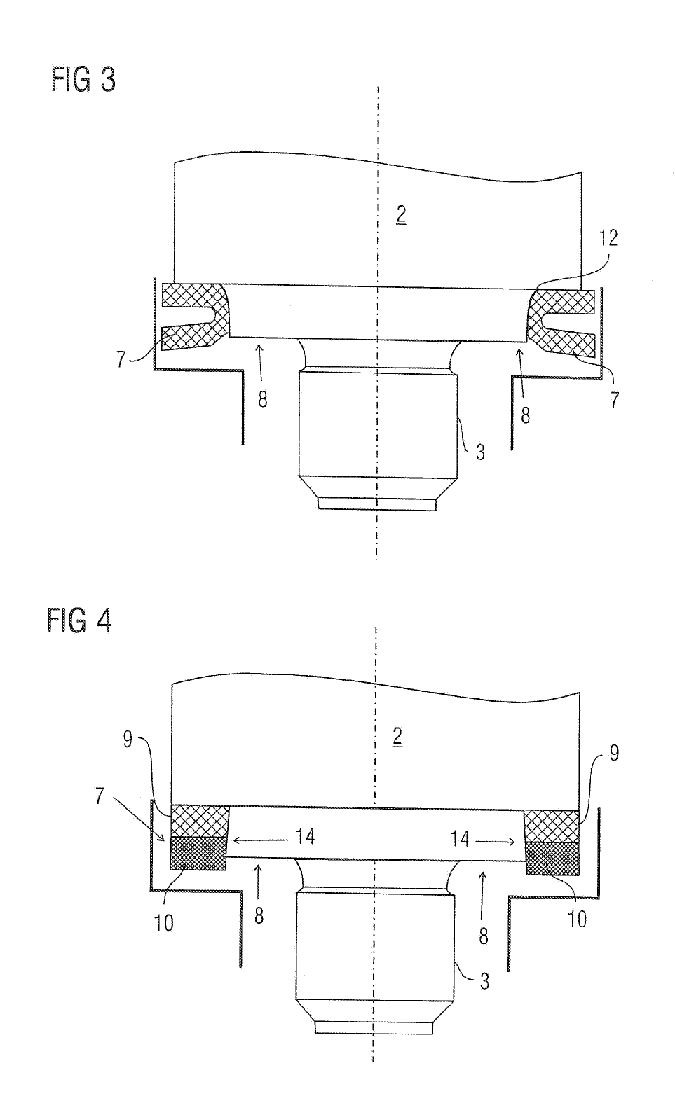

FIG. 3 a longitudinal section through the housing with an elastically configured damping element;

FIG. 4 a longitudinal section through the housing with a damping element, consisting of a combination of a plastic ring and an elastomer vulcanized on the ring;

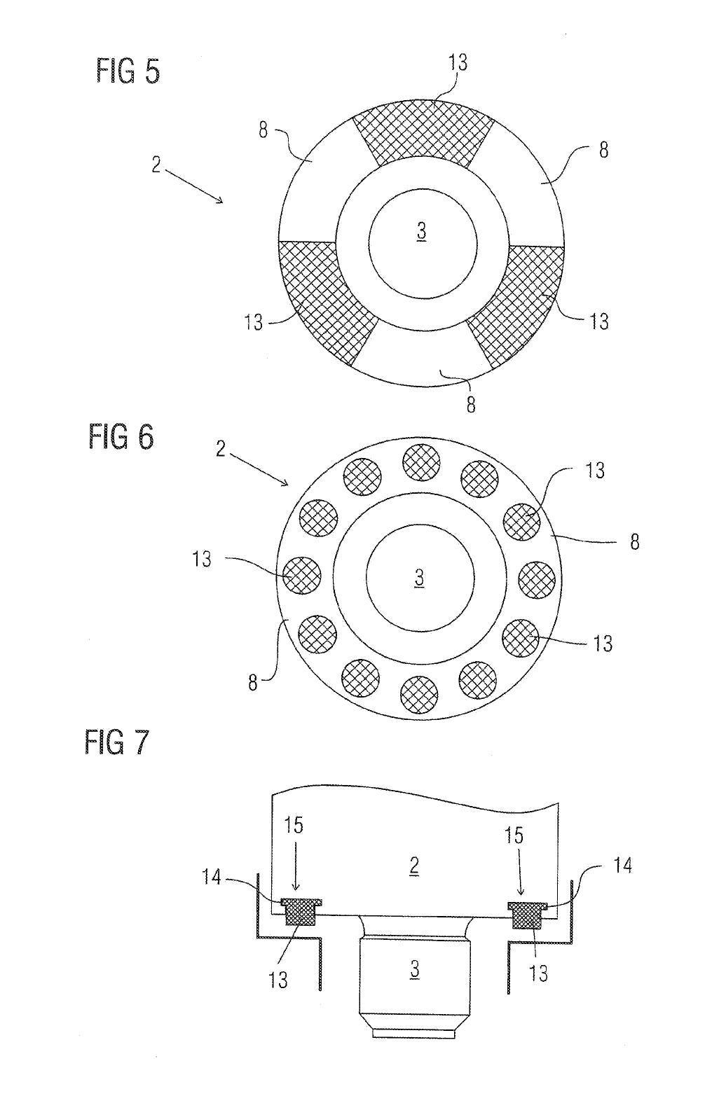

FIG. 5 a top view on a housing with vulcanized segmented damping elements;

FIG. 6 a top view on a housing with a plurality of round damping elements; and

FIG. 7 a longitudinal section through the housing of FIG. 6.

FIG. 1 shows a side view of a preferred embodiment of the axial ball joint 1 according to the invention. The ball joint 1 includes a housing 2, which has on the bottom side a housing pin 3. A bearing shall, which is not visible in the side view and into which a partially visible ball 4 with a pivot pin 5 is inserted, is disposed inside the housing 2. The pivot pin protrudes from the housing 2 through an opening of the housing 2. An annular damping element 7 is inserted in a step or a shoulder, which is not visible in FIG. 1, on the outside at the bottom side of the housing 2 which is located opposite the opening of the housing 2 through which the pivot pin 5 protrudes.

When the axial ball joint 1 constructed according to the invention is used in a steering gear, the maximal excursion can be limited by a mechanical stop on the housing 2. The damping element 7 prevents a hard impact. The steering gear housing typically operates as a mechanical stop. Employing the damping element significantly reduces the mechanical load on the components of the entire steering system, while also reducing noise generation. With the simple structure of the axial ball joint 1 according to the invention with the integrated damping which employs one or more damping elements on the housing of the axial ball joint, effective impact damping can be implemented in a simple and cost-effective manner.

FIG. 2 shows the axial ball joint 1 of FIG. 1 in a longitudinal section. In this sectional view, the design of the axle ball joint 1 can be better visualized. FIG. 2 shows a housing with an attached housing pin 3. The ball 4 which transitions into a pivot pin 5 is located inside the housing 2. A bearing shell 6 which provides a clean seat for the ball 4 in the housing 2 is disposed between the housing 2 and the ball 4. Fundamentally, the bearing shall 6 also produces a certain damping effect, but this damping effect cannot completely assume the function of the damping element 7. This damping element 7 is implemented as an annular bead, wherein an additional metal insert 11, which is firmly pressed onto the shoulder 12, improves seating of the damping element 7 on the shoulder 12 of the housing 2.

This section through the housing 2 also shows an additional surface 8 disposed between the housing pin 3 and the damping element 7 which can operate as an additional impact surface should the spring deflection of the damping element become excessive.

FIGS. 3 and 4 show two different embodiments of annular damping elements 7 in cross-section.

For example, FIG. 3 shows an embodiment of a damping element 7 as a plastic ring with a V-shape. This structure allows elastic deformation of the damping element without the use of an elastomer. Such damping elements may basically be made, for example, of plastic. Alternatively, this damping element can also be produced from spring steel or the like for operation with higher loads.

FIG. 4 shows a damping element 7 structured as a combination of a plastic ring 9 with an elastomer 10 vulcanized on the plastic ring 9. The plastic ring 9 provides a firm seat on the shoulder on the housing 2, whereas the elastomer component 10 takes over the axial damping work, meaning the elastic deformation during impact. This embodiment also shows that the shoulder has a conical shape 14 which additionally improves the seat for the entire damping element, in particular the plastic ring 9.

It should be mentioned that in the context of the invention several annular damping elements arranged concentrically on the housing of the axial ball joint may be used.

While FIGS. 1 to 4 each show annular damping elements, FIGS. 5 to 7 show two modified embodiments with several damping elements which do not have an annular shape and which are arranged on the housing surface 8 of the housing 2 that has the pin.

FIG. 5 shows an embodiment of a housing 2 with three damping elements 13 formed as segments of a circle, which are arranged on a housing surface 8 concentrically around the housing pin and which are vulcanized on the housing surface. Such embodiment can be manufactured easily and cost-effectively.

FIG. 6 also shows in an axial top view a housing 2, as seen from the side of the housing pin 3, wherein a plurality of circular damping elements 13 are inserted into corresponding recesses provided on the housing surface 8. These recesses can be more easily seen in FIG. 7, which shows a cross section of the housing of FIG. 6. The individual recesses 15 in which the damping elements 13 are inserted can be easily recognized. In addition, these recesses 15 have undercuts 14 in which the inserted damping elements 13 can be additionally be clamped to attain a very firm seat in the recess.

It should be noted that such undercuts can also be implemented in conjunction with the annular damping elements illustrated in FIGS. 1 to 4, thereby also improving seating of the annular damping elements.

Although in the illustrated preferred examples, the damping elements are at least partially made of an elastomer, the subject matter of the invention shall not be limited to these embodiments. It is also within the scope of the invention to construct the annular damping elements arranged above the housing pin or the plurality of individual damping elements arranged above the housing pin as separately formed spring elements, for example disk springs, or other elastic inserts or annular spring elements.

It will be understood that the aforedescribed features of the invention can not only be used in the described combination, but also in other combinations or separately, without going beyond the scope of the invention. It is also within the context of the invention to reverse the functions of the individual mechanical elements of the invention.

### LIST OF REFERENCES SYMBOLS

Axial ball bearing
Housing
Housing pin
Ball bearing
Pivot pin
Bearing shell
Damping element
Housing surface
Plastic ring
Elastomer
Metal insert
Step, shoulder
Damping elements
Undercut
Recess

1. An axial ball bearing, comprising a housing having a top and a bottom and which is open on the top and has a housing pin arranged on the bottom of the housing, a ball with a pivot pin and a bearing shell arranged between the housing and the ball, wherein the housing comprises at least one elastic damping element for impact damping on the housing, the elastic damping element is disposed on the housing near the housing pin.

2. The axial ball bearing according to claim 1, wherein the damping element has an annular shape.

3. The axial ball bearing according to claim 2, wherein the housing at the bottom includes an unprotected housing surface, which is set back with respect to the at least one annular damping element, and which is formed between the annular damping element and the housing pin.

4. The axial ball bearing according to claim 2, wherein the bottom of the housing includes a shoulder and wherein the annular damping element is inserted in the shoulder.

5. The axial ball bearing according to claim 2, wherein the annular damping element is inserted in a groove on the housing side of the housing that includes the housing pin.

6. The axial ball bearing according to claim 5, wherein the annular damping element is at least partially made of an elastomer.

7. The axial ball bearing according to claim 2, wherein the annular damping element comprises a plastic ring and an elastomer overmolded on the plastic ring.

8. The axial ball bearing according to claim 2, wherein the annular damping element is vulcanized directly to the housing.

9. The axial ball bearing according to claim 2, wherein the annular damping element is adhesively bonded directly to the housing.

10. The axial ball bearing according to claim 2, wherein the annular damping element is pressed onto the housing.

11. The axial ball bearing according to claim 2, wherein the annular damping element comprises a plastic ring having a spring characteristic.

12. The axial ball bearing according to claim 2, wherein the annular damping element comprises a metal insert.

13. The axial ball bearing according to claim 2, wherein the shoulder or the groove has an undercut.

14. The axial ball bearing according to claim 2, wherein the annular damping element is exclusively made of a metal.

15. The axial ball bearing according to claim 1, further comprising several damping elements which are placed on the housing side of the housing that has the housing pin.

16. The axial ball bearing according to claim 15, wherein the damping elements are constructed as segments of a circle.

17. The axial ball bearing according to claim 15, wherein the damping elements have a circular shape.

18. The axial ball bearing according to claim 15, wherein the damping elements are inserted in recesses on the housing side that has the housing pin.

19. The axial ball bearing according to claim 15, wherein the damping elements are at the least partially made of an elastomer.

20. The axial ball bearing according to claim 15, wherein the damping elements are made of a combination of plastic and an elastomer overmolded on the plastic.

21. The axial ball bearing according to claim 15, wherein the damping elements are vulcanized directly on the housing.

22. The axial ball bearing according to claim 15, wherein the damping elements are adhesively bonded directly onto the housing.

23. The axial ball bearing according to claim 15, wherein the damping elements are pressed into corresponding recesses on the housing side of the housing that has the housing pin.

24. The axial ball bearing according to claim 15, wherein the damping elements comprise a metallic insert.

25. The axial ball bearing according to claim 15, wherein the recesses comprise undercuts which improved seating of the damping elements.

26. The axial ball bearing according to claim 15, wherein the damping elements are made exclusively of metal.
